(19) United States
(12) Patent Application Publication
(10) Pub. No.: US 2023/0071387 A1
(43) Pub. Date: Mar. 9, 2023

(54) COATED SEPARATOR, ELECTROCHEMICAL CELL COMPRISING A COATED SEPARATOR, AND METHOD OF MAKING A COATED SEPARATOR

(71) Applicant: ROGERS CORPORATION, Chandler, AZ (US)

(72) Inventors: Yang ZHONG, Shanghai (CN); Wei WANG, Waltham, MA (US); Jing JIANG, Suzhou (CN)

(21) Appl. No.: 17/793,512

(22) PCT Filed: Dec. 21, 2020
(86) PCT No.: PCT/US2020/066304

§ 371 Date: Jul. 18, 2022

Related U.S. Application Data
(60) Provisional application No. 62/964,749, filed on Jan. 23, 2020.

(51) Int. Cl. H01M 50/451; H01M 50/414; H01M 50/434; H01M 50/446; H01M 50/403

(52) U.S. Cl. CPC H01M 50/451; H01M 50/414; H01M 50/434; H01M 50/446; H01M 50/403; H01M 10/0525

(57) ABSTRACT

A coated separator includes a porous separator base material including a porous polymer film; a first coating layer including electrochemically stable thermoplastic polymer particles disposed on a first surface of the porous separator base material, wherein the electrochemically stable thermoplastic polymer particles have a melting temperature of 90 to 135° C.; and a second coating layer including ceramic particles having an average particle size of greater than 100 nanometers; wherein the second coating layer is disposed on the first coating layer on a side opposite the porous separator base material; or the second coating layer is disposed on the porous separator base material on a second side opposite first coating layer; or the first coating layer and the second coating layer are combined to form an intermixed coating layer disposed on the first surface of the porous separator base material. Electrochemical cells, a device including an electrochemical cell, and a method of making the coated separator are also described.

### CROSS REFERENCE TO RELATED APPLICATIONS

This application claims the benefit of U.S. Application No. 62/964,749, filed on Jan. 23, 2020, which is incorporated herein by reference in its entirety.

### BACKGROUND

Separators for electrochemical cells, for example lithium ion batteries, are generally required to maintain their structural integrity at high temperatures. Separators can also provide shutdown behavior. Many materials currently used for separators offer the desired shut down properties, but disadvantageously can exhibit limited stability at high temperatures. Softening or melting of a polymer separator can lead to shutdown behavior and high shrinkage can lead to poor dimensional stability.

Accordingly, there remains a continuing need in the art for improved separator materials that can offer both the desired shutdown behavior in combination with good high temperature stability (e.g., good dimensional stability and low shrinkage).

### SUMMARY

A coated separator comprises a porous separator base material comprising a porous polymer film; a first coating layer comprising electrochemically stable thermoplastic polymer particles disposed on a first surface of the porous separator base material, wherein the electrochemically stable thermoplastic polymer particles have a melting temperature of 90 to 135° C.; and a second coating layer comprising ceramic particles having an average particle size of greater than 100 nanometers; wherein the second coating layer is disposed on the first coating layer on a side opposite the porous separator base material; or the second coating layer is disposed on the porous separator base material on a second side opposite first coating layer; or the first coating layer and the second coating layer are combined to form an intermixed coating layer disposed on the first surface of the porous separator base material.

An electrochemical cell comprises the coated separator.

A lithium ion battery comprises the coated separator.

A device comprises the lithium ion battery.

A method of making the coated separator comprises applying the first coating layer to the separator and applying the second coating layer to the separator.

The above described and other features are exemplified by the following figures and detailed description.

### BRIEF DESCRIPTION OF THE DRAWINGS

The following figures represent exemplary embodiments wherein like elements are numbered alike.

FIG. 1 shows a schematic illustration of a coated separator according to an embodiment of the present disclosure, where polymer particles and ceramic particles are coated on the same side of a polymeric base material.

FIG. 2 shows a schematic illustration of a coated separator according to an embodiment of the present disclosure, where polymer particles and ceramic particles are coated on opposite sides of a polymeric base material.

FIG. 3 shows a schematic illustration of a coated separator according to an embodiment of the present disclosure, where polymer particles and ceramic particles are coated on the same side of a polymeric base material and form an intermixed coating layer.

### DETAILED DESCRIPTION

The present inventors have advantageously found that an improved separator material can be provided by coating a porous polymer film with a first coating layer comprising electrochemically stable thermoplastic polymer particles and a second coating layer comprising ceramic particles. In particular, the shutdown temperature can be significantly reduced, and thermal stability of the separator can be improved.

Accordingly, an aspect of the present disclosure is a coated separator. The coated separator comprises a porous separator base material, a first coating layer, and a second coating layer. The porous separator base material comprises a porous polymer film. The porous polymer film can comprise, for example, polyethylene, polypropylene, polyimide, polyethylene terephthalate, polytetrafluoroethylene, polyvinylidene fluoride, or a combination thereof. In some embodiments, the porous polymer film can preferably comprise a porous polyolefin film, for example, a polyethylene film or a polypropylene film. The porous separator base material can comprise a plurality of interconnected channels (also referred to as “pores”) extending from a first surface to a second surface of the porous separator base material. The diameter of the pores of the porous separator base material can be, for example 0.01 to 10 micrometers, for example 0.01 to 0.05 micrometers. The porous separator base material can have a porosity of 1 to 50%, or 20 to 50%, or 30 to 45%. The porous separator base material can have a thickness of, for example, 1 to 20 micrometers, preferably 5 to 14 micrometers, more preferably 5 to 9 micromeres, even more preferably 5 to 7 micrometers. It can be advantageous to use a thin separator base material to increase the energy density of the separator.

The coated separator further comprises a first coating layer disposed on a first surface of the porous separator base material. The first coating layer comprises electrochemically stable thermoplastic polymer particles. As used herein, the term “electrochemically stable” refers to the stability of the polymer particles towards lithium in a working electrochemical cell at 4.5 volts or greater. The electrochemically stable thermoplastic polymer particles can have a melting temperature of 90 to 135° C., for example 95 to 125° C., or 95 to 115° C., or 98 to 110° C. Melting temperature of the polymer particles can be determined by, for example, differential scanning calorimetry (DSC). Exemplary electrochemically stable thermoplastic polymer particles can include, but are not limited to, polyurethane, polyethylene oxide, polyethylene, ethylene vinyl acetate polymers, ethylene acrylic acid polymers, polyester, styrene acrylate polymers, styrene-butadiene polymer, derivatives thereof, or a combination thereof.

The electrochemically stable thermoplastic polymer particles can have an average diameter of 0.3 to 5 micrometers, or 0.5 to 5 micrometers, or 0.3 to 3 micrometers. The polymer particles preferably have a particle diameter larger than the average pore diameter of the porous separator base material. The polymer particles are preferably spherical in shape, with a relatively uniform size and shape distribution. Average particle size can be determined, for example, by laser light scattering techniques. Particle shape can be analyzed, for example, using scanning electron microscopy (SEM) techniques.

In addition to the first coating layer, the coated separator further comprises a second coating layer. The second coating layer comprises ceramic particles. The ceramic particles can have an average particle size of greater than 100 nanometers, or greater than 250 nanometers, or greater than 500 nanometers. In some embodiments the ceramic particles can have an average particle size of 500 nanometers to 5 micrometers, or 500 nanometers to 3 micrometers, or 500 nanometers to 1 micrometer. The second coating layer can have a thickness of 0.5 to 6 micrometers.

The ceramic particles can comprise SiO₂, Al₂O₃, boehmite, MgO, TiO₂, ZrO₂, SnO₂, Al(OH)₃, BaTiO₂, ZnO₂, Mg(OH)₂, Ti(OH)₄, AlN, SiC, BN, and the like, or a combination thereof. In some embodiments, the ceramic particles do not comprise any surface coating. In some embodiments, the second coating layer comprising the ceramic particles can exclude a polymeric component. In some embodiments, conductive particles (e.g., comprising carbonaceous materials such as graphite, carbon black, and the like) can be excluded from either or both of the coating layers.

In some embodiments, the first coating layer, the second coating layer, or both can optionally further include a polymer binder material. Exemplary polymer binder materials can include, but are not limited to, carboxylmethyl cellulose (CMC), hydroxyethyl cellulose (HEC), ethylene vinyl acetate (EVA), ethylene acrylic acid copolymer (EAA), polyvinyl alcohol (PVA), polyvinylbutyral (PVB), polyethylene glycol (PEG), acrylic resins, polyvinylidene fluoride (PVDF), /polyvinylidene fluoride-co-hexafluoropropylene (PVDF-HFP), or a combination thereof. In some embodiments, the polymeric binder can comprise an acrylic resin dispersion in water. In some embodiments, the first coating layer, the second coating layer, or both can exclude a polymer binder.

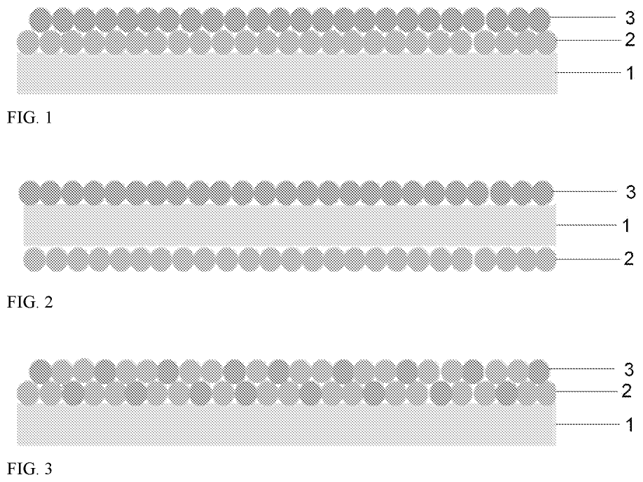

The coated separator of the present disclosure comprises the porous separator base material, the first coating layer, and the second coating layer arranged in a particular order. In an embodiment, the first coating layer is disposed on the first surface of the porous separator base material, and the second coating layer is disposed on the first coating layer on a side opposite the porous separator base material. A schematic illustration of this arrangement is shown in FIG. 1, wherein the porous separator base material 1 is coated with the first coating layer 2, and the second coating layer 3 is disposed on the first coating layer. In another embodiment, the first coating layer is disposed on the first surface of the porous separator base material, and the second coating layer is disposed on the porous separator base material on a second side opposite the first coating layer. A schematic illustration of this arrangement is shown in FIG. 2, wherein the porous separator base material 1 is coated with the first coating layer 2 on a first side, and coated with the second coating layer 3 on a second, opposite side. In the embodiments shown in FIG. 1 and FIG. 1, the first coating layer can be in direct contact with the porous separator base material on the first side of the porous separator base material (i.e., no intervening layers are present between the porous separator base material and the first coating layer). For example, the coated separator can exclude an adhesive layer. In another embodiment, the first and second coating layers are combined to form an intermixed coating layer disposed on the first surface of the porous separator base material. A schematic illustration of the arrangement is shown in FIG. 3, where the porous separator base material 1 is coated with an intermixed coating layer comprising the first coating layer 2 and the second coating layer 3. The intermixed coating layer can be in direct contact with the separator base material (i.e., no intervening layers are present between the intermixed layer and the separator base material).

Advantageously, the coated separator of the present disclosure can exhibit a reduced shutdown temperature. For example, the coated separator can have a shutdown temperature of less than 130° C., or 90 to 125° C., or 90 to 120° C., or 100 to 120° C.

The coated separator can be made by a method comprising applying the first coating layer to the separator and applying the second coating layer to the separator. When the first coating layer and the second coating layer are present on opposite sides of the separator as in FIG. 2, each coating layer can be coated in any order. In some embodiments, the coating layers can be applied to the respective sides of the separator simultaneously. In some embodiments, the first coating layer is applied to the separator, and the second coating layer is subsequently applied to the first coating layer to provide the coated separator of FIG. 1. In some embodiments, the first coating material and the second coating material can be mixed, and the mixture can be applied to the separator to provide the coated separator of FIG. 3. Applying the first coating layer, the second coating layer, or both can comprise, for example, dip coating, slot-die extrusion coating, blade coating, micron gravure coating, roll coating, or a combination thereof. In some embodiments, micron gravure coating can be preferred.

The coated separator of the present disclosure can be particularly useful in an electrochemical cell. Accordingly, an electrochemical cell comprising the coated separator represents another aspect of the present disclosure. In some embodiments, the electrochemical cell can be a lithium ion battery. The lithium ion battery can include a positive electrode, a negative electrode, an electrolyte disposed between the positive and the negative electrode, and the coated separator of the present disclosure disposed between the positive electrode and the negative electrode. In the lithium ion battery, the positive and the negative electrodes are not particularly limited and can be manufactured by binding an electrode active material to an electrode current collector. Exemplary active materials that can be used in a positive electrode can be, for example, lithium manganese oxides, lithium cobalt oxides, lithium nickel oxides, lithium iron phosphates, and lithium transition metal oxides thereof. Exemplary active materials that can be used in a negative electrode can be, for example, lithium, lithium alloys, silicon alloys, and lithium intercalation materials such as carbon, petroleum coke, activated carbon, graphite, and other carbonaceous materials. Non-limiting examples of a positive electrode current collector can include aluminum foils, nickel foils, or a combination thereof. Non-limiting examples of a negative electrode current collector can include copper foils, gold foils, nickel foils, copper alloy foils, or a combination thereof. The electrolyte can be a liquid electrolyte, for example comprising an organic solvent and an electrolyte salt, for example a lithium salt. A device comprising the lithium ion battery represents another aspect of the present disclosure.

This disclosure is further illustrated by the following examples, which are non-limiting.

### EXAMPLES

The base separator used in the following example was a polyethylene film having a porosity of 30 to 60%, and a pore size of 0.01 to 0.2 micrometers. Electrochemically stable polymer particles are a polyethylene (PE) wax emulsion having a melting point of 105° C., an emulsion comprising PE derivatives, a styrene acrylate (SA) emulsion having a melting point of 108° C., or an emulsion comprising polystyrene derivatives. The ceramic material used was boehmite/Al₂O₃. Coated structures were prepared where the base separator was coated with the electrochemically stable polymer particles, the mixture of electrochemical stable polymer particles and ceramic, or a multilayer structure was prepared wherein the electrochemically stable polymer particles were coated on the PE base separator, and the ceramic particles were coated on the electrochemically stable polymer coating layer, or the ceramic particles were coated on opposite sides of PE base separator. The thickness of the functional coating layer ranged from 0.1 to 10 micrometers. Average particle diameter was 0.05 to 5 micrometers.

Gurley value is an important indicator for the coated separator. Separator Gurley value is the time required for a given volume of air to pass through a separator. The Gurley value reflects the tortuosity of the pores, when the porosity and thickness of the separator is fixed. This means it is difficult for air to pass through a separator with a high Gurley value and ion permeability is low. A separator Gurley value is measured using measurement equipment made in accordance with ASTM D726(B). In this application, porosity values are measured using a Gurley 4110N/4320DN Tester under ambient condition. Each sample was measured five times, and the average was taken. Gurley values are reported in sec/100 cc. Gurley values were determined at room temperature (“r.t.”), after 1 hour at 90° C., after 1 hour at 100° C., after 1 hour at 110° C., after 1 hour at 120° C., or after 1 hour at 130° C. “X” in Table 1 indicates the Gurley value is infinite. Shutdown temperature was determined when Gurley value was determined to be infinite, indicating separator shut down.

The separator materials used in each of the following Examples are summarized in Table 1. The porosity of the base PE separator used was 39%.

TABLE 1

| | Separator | Mean pore size (Standard |
|---|---|---|
| Example | Description | Deviation) (nm) |
| Comparative | Base PE Separator | 22.0 (11.1) |
| Example 1 | | |
| Example 1 | Electrochemically stable | 23.5 (11.7) |
| | polymer particle coated | |
| | separator | |
| Example 2 | Ceramic particle | 29.2 (7.2) |
| | coated separator | |
| Example 3 | Electrochemically stable | 22.2 (10.5) |
| | polymer and ceramic | |
| | coated separator | |

Results are summarized in Table 2.

TABLE 2

| | Comparative | | | |
|---|---|---|---|---|
| ITEMS | Example 1 | Example 1 | Example 2 | Example 3 |
| Avg. Gurley value | 197.5 | 217.9 | 221.7 | 239.9 |
| (r.t.) | | | | |
| S.D. | 1.1 | 1.5 | 4.6 | 1.4 |
| Avg. Gurley value | 203.0 | 245.8 | 228.9 | 263.7 |
| (80 C./1 hr) | | | | |
| S.D. | 0.9 | 1.6 | 6.3 | 2.7 |
| Avg. Gurley value | 208.3 | 257.5 | 227.9 | 280.9 |
| (90 C./1 hr) | | | | |
| S.D. | 1.4 | 2.0 | 5.7 | 1.8 |
| Avg. Gurley value | 205.5 | 3242.4 | 233.2 | 1280.3 |
| (100 C./1 hr) | | | | |
| S.D. | 1.1 | — | 0.9 | 96.2 |
| Avg. Gurley value | 216.7 | Shutdown | 251.0 | 2249.2 |
| (110 C./1 hr) | | | | |
| S.D. | 2.5 | | 3.0 | 221.8 |
| Avg. Gurley value | 285 | | 337.0 | Shutdown |
| (120 C./1 hr) | | | | |
| S.D. | 13.1 | | 20.3 | |
| Avg. Gurley value | Shutdown | | Shutdown | |
| (130 C./1 hr) | | | | |
| S.D. | | | | |
| Shutdown (° C.) | 130 | 110 | 130 | 120 |

As shown in Table 2, when the coated separators are used, the shutdown point for a PE separator is tunable and can be reduced from 130° C. to as low as 100° C.

The thermal stability of the separators was also examined. As shown in Table 3 below, the coated separator materials possess higher thermal stability, demonstrated as low shrinkage at high temperature. Table 3 shows shrinkage in the transverse and machine directions (TD and MD) for each sample at a temperature of 90, 100, 110, and 120° C. Each sample was tested under two-piece glass clamping. At higher temperatures, the separator of Example 1 (electrochemically stable polymer particle coated separator) can have a positive impact on the thermal stability. The ceramic coated separator of Example 2 was observed to have a positive impact on thermal stability across all temperatures tested.

TABLE 3

| | | Ratio (%) | Ratio (%) | Ratio (%) | Ratio (%) |
|---|---|---|---|---|---|
| | | (90 C./ | (100 C./ | (110 C./ | (120 C./ |
| Separator | | 1 h) | 1 h) | 1 h) | 1 h) |
| Comparative | TD | 0.57 | 0.57 | 0.57 | −0.29 |
| Example 1 | | 0.57 | 0.57 | 0.57 | −0.29 |
| | MD | −1.11 | −2.22 | −2.22 | −4.00 |
| | | −1.11 | −2.22 | −2.22 | −4.00 |
| Example 1 | TD | 1.43 | 1.14 | 1.14 | 0.00 |
| | | 1.43 | 1.14 | 1.14 | 0.00 |
| | MD | −0.89 | −1.11 | −1.56 | −2.22 |
| | | −0.89 | −1.11 | −1.56 | −2.22 |
| Example 2 | TD | 0.29 | 0.29 | 0.29 | 0.00 |
| | | 0.29 | 0.29 | 0.29 | 0.00 |
| | MD | −0.44 | −0.89 | −1.11 | −1.11 |
| | | −0.44 | −0.89 | −1.11 | −1.11 |
| Example 3 | TD | 1.43 | 1.43 | 1.43 | 0.00 |
| | | 1.43 | 1.43 | 1.43 | 0.00 |
| | MD | −0.22 | −0.44 | −1.11 | −2.22 |
| | | −0.22 | −0.44 | −1.11 | −2.22 |

This disclosure further encompasses the following aspects.

Aspect 1: A coated separator comprising: a porous separator base material comprising a porous polymer film; a first coating layer comprising electrochemically stable thermoplastic polymer particles disposed on a first surface of the porous separator base material, wherein the electrochemically stable thermoplastic polymer particles have a melting temperature of 90 to 135° C.; and a second coating layer comprising ceramic particles having an average particle size of greater than 100 nanometers; wherein the second coating layer is disposed on the first coating layer on a side opposite the porous separator base material; or the second coating layer is disposed on the porous separator base material on a second side opposite first coating layer; or the first coating layer and the second coating layer are combined to form an intermixed coating layer disposed on the first surface of the porous separator base material.

Aspect 2: The coated separator of aspect 1, wherein the first coating layer is disposed on the first side of the porous separator base material and the second coating layer is disposed on the first coating layer on a side opposite the porous separator base material.

Aspect 3: The coated separator of aspect 1, wherein the first coating layer is disposed on the first side of the porous separator base material and the second coating layer is disposed on the second, opposite side of the porous separator base material.

Aspect 4: The coated separator of aspect 2 or 3, wherein the first coating layer is in direct contact with the porous separator base material on the first side of the porous separator base material.

Aspect 5: The coated separator of aspect 1, wherein the first coating layer and the second coating layer are combined to form an intermixed coating layer disposed on the first surface of the porous separator base material.

Aspect 6: The coated separator of any of aspects 1 to 5, wherein the porous separator base material comprises polyethylene, polypropylene, polyimide, polyethylene terephthalate, polytetrafluoroethylene, polyvinylidene fluoride, or a combination thereof.

Aspect 7: The coated separator of any of aspects 1 to 6, wherein the porous separator base material comprises a plurality of interconnected channels extending from a first surface to a second surface of the porous separator base material.

Aspect 8: The coated separator of any of aspects 1 to 7, wherein the electrochemically stable thermoplastic polymer particles comprise polyurethane, polyethylene oxide, polyethylene, ethylene vinyl acetate polymers, ethylene acrylic acid polymers, polyester, styrene acrylate polymers, styrene-butadiene polymer, or a combination thereof.

Aspect 9: The coated separator of any of aspects 1 to 8, wherein electrochemically stable thermoplastic polymer particles have an average diameter of 0.5 to 5 micrometers.

Aspect 10: The coated separator of any of aspects 1 to 9, wherein the ceramic particles comprise SiO₂, Al₂O₃, boehmite, MgO, TiO₂, ZrO₂, SnO₂, Al(OH)₃, BaTiO₂, ZnO₂, Mg(OH)₂, Ti(OH)₄, AlN, SiC, Bn, or a combination thereof.

Aspect 11: The coated separator of any of aspects 1 to 10, wherein the ceramic particles have an average diameter of 0.5 to 3 micrometers.

Aspect 12: The coated separator of any of aspects 1 to 11, wherein the coated separator exhibits a shutdown temperature of less than 130° C., preferably 90 to 125° C., more preferably 90 to 120° C., even more preferably 100 to 120° C.

Aspect 13: The coated separator of any of aspects 1 to 12, wherein the first coating layer, the second coating layer, or both exclude a polymer binder.

Aspect 14: The coated separator of any of aspects 1 to 13, wherein the ceramic particles do not comprise a surface coating.

Aspect 15: An electrochemical cell comprising the coated separator of any of aspects 1 to 14.

Aspect 16: A lithium ion battery comprising the coated separator of any of aspects 1 to 14.

Aspect 17: The lithium ion battery of aspect 16 comprising a positive electrode; a negative electrode; an electrolyte disposed between the positive electrode and the negative electrode; and the coated separator of any of aspects 1 to 14 disposed between the positive electrode and the negative electrode.

Aspect 18: A device comprising the lithium ion battery of aspect 16 or 17.

Aspect 19: A method of making the coated separator of any of aspects 1 to 14, the method comprising applying the first coating layer to the separator and applying the second coating layer to the separator.

Aspect 20: The method of aspect 19, wherein applying the first coating layer, second coating layer, or both, comprises dip coating, slot-die extrusion coating, blade coating, micron gravure coating, roll coating, or a combination thereof.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. The term “combination thereof” as used herein includes one or more of the listed elements, and is open, allowing the presence of one or more like elements not named. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A coated separator comprising:
a porous separator base material comprising a porous polymer film;
a first coating layer comprising electrochemically stable thermoplastic polymer particles disposed on a first surface of the porous separator base material, wherein the electrochemically stable thermoplastic polymer particles have a melting temperature of 90 to 135° C.; and
a second coating layer comprising ceramic particles having an average particle size of greater than 100 nanometers;
wherein
the second coating layer is disposed on the first coating layer on a side opposite the porous separator base material; or
the second coating layer is disposed on the porous separator base material on a second side opposite first coating layer; or
the first coating layer and the second coating layer are combined to form an intermixed coating layer disposed on the first surface of the porous separator base material.

2. The coated separator of claim 1, wherein the first coating layer is disposed on the first side of the porous separator base material and the second coating layer is disposed on the first coating layer on a side opposite the porous separator base material.

3. The coated separator of claim 1, wherein the first coating layer is disposed on the first side of the porous separator base material and the second coating layer is disposed on the second, opposite side of the porous separator base material.

4. The coated separator of claim 2, wherein the first coating layer is in direct contact with the porous separator base material on the first side of the porous separator base material.

5. The coated separator of claim 1, wherein the first coating layer and the second coating layer are combined to form an intermixed coating layer disposed on the first surface of the porous separator base material.

6. The coated separator of claim 1, wherein the porous separator base material comprises polyethylene, polypropylene, polyimide, polyethylene terephthalate, polytetrafluoroethylene, polyvinylidene fluoride, or a combination thereof.

7. The coated separator of claim 1, wherein the porous separator base material comprises a plurality of interconnected channels extending from a first surface to a second surface of the porous separator base material.

8. The coated separator of claim 1, wherein the electrochemically stable thermoplastic polymer particles comprise polyurethane, polyethylene oxide, polyethylene, ethylene vinyl acetate polymers, ethylene acrylic acid polymers, polyester, styrene acrylate polymers, styrene-butadiene polymer, or a combination thereof.

9. The coated separator of claim 1, wherein electrochemically stable thermoplastic polymer particles have an average diameter of 0.5 to 5 micrometers.

10. The coated separator of claim 1, wherein the ceramic particles comprise SiO₂, Al₂O₃, boehmite, MgO, TiO₂, ZrO₂, SnO₂, Al(OH)₃, BaTiO₂, ZnO₂, Mg(OH)₂, Ti(OH)₄, AlN, SiC, Bn, or a combination thereof.

11. The coated separator of claim 1, wherein the ceramic particles have an average diameter of 0.5 to 3 micrometers.

12. The coated separator of claim 1, wherein the coated separator exhibits a shutdown temperature of less than 130° C.

13. The coated separator of claim 1, wherein the first coating layer, the second coating layer, or both exclude a polymer binder.

14. The coated separator of claim 1, wherein the ceramic particles do not comprise a surface coating.

15. An electrochemical cell comprising the coated separator of claim 1.

16. A lithium ion battery comprising the coated separator of claim 1.

17. The lithium ion battery of claim 16 comprising a positive electrode;
a negative electrode;
an electrolyte disposed between the positive electrode and the negative electrode; and
the coated separator of claim 1 disposed between the positive electrode and the negative electrode.

18. A device comprising the lithium ion battery of claim 16.

19. A method of making the coated separator of claim 1, the method comprising applying the first coating layer to the separator and applying the second coating layer to the separator.

20. The method of claim 19, wherein applying the first coating layer, second coating layer, or both, comprises dip coating, slot-die extrusion coating, blade coating, micron gravure coating, roll coating, or a combination thereof.
